(19) United States
(12) Patent Application Publication
(10) Pub. No.: US 2011/0207379 A1
(43) Pub. Date: Aug. 25, 2011

(54) FIRE-RESISTANT MATERIAL FOR VEHICLE SEATS

(75) Inventor: Hans Henkes, Worms (DE)

(73) Assignee: CARL FREUDENBERG KG, Weinheim (DE)

(21) Appl. No.: 13/033,674

(22) Filed: Feb. 24, 2011

(30) Foreign Application Priority Data
Feb. 25, 2010 (DE) 10 2010 009 351.3

(51) Int. Cl. B32B 5/26; B32B 5/02

(52) U.S. Cl. 442/36; 442/1

(57) ABSTRACT

A material providing a fire-resistant finish for vehicle seats includes a first layer in the form of a grid, a second nonwoven layer including aramid fibers, and a third nonwoven layer including pre-oxidized polyacrylonitrile fibers.

### CROSS REFERENCE TO RELATED APPLICATIONS

This application claims priority from German Patent Application No. DE 10 2010 009 351.3-26, filed Feb. 25, 2010, which is hereby incorporated by reference herein in its entirety.

### FIELD

The present invention relates to a material used for a fire-resistant finish for vehicle seats.

### BACKGROUND

Fire-resistant materials are known.

Such materials have several features. They typically provide good thermal insulation and, at the same time, exhibit high flame-resistance or fire-resistance. In particular, they should not burn or disintegrate when exposed to fire, and preferably they should not lose too much mass.

Furthermore, these materials should preferably display high mechanical abrasion resistance and have a long service life under normal conditions of use.

### SUMMARY

The present invention provides an inexpensive material that has high mechanical strength and is highly fire-resistant.

In an embodiment, the present invention provides a material providing a fire-resistant finish for vehicle seats including a first layer in the form of a grid, a second nonwoven layer including aramid fibers, and a third nonwoven layer including pre-oxidized polyacrylonitrile fibers.

### DETAILED DESCRIPTION

It has been recognized that an arrangement in accordance with the invention of aramid fibers and pre-oxidized polyacrylonitrile fibers in separate layers results in high fire-resistance and mechanical strength. Here, completely in contrast to conventional materials, the fibers of the layers are explicitly not mixed with each other in a single layer, but rather, are arranged in separate layers. In this manner, each layer can fulfill its own specific function. Each individual layer contains only the substances that it needs to fulfill this function and its effect is not weakened by foreign substances. Consequently, the positive properties of the individual substances are cumulative, which precisely would not be ensured if the substances or fibers were to be mixed in a single layer. In this context, it has been concretely recognized that the grid ensures abrasion resistance. Aramid fibers make the material highly fire-resistant and, at the same time, mechanically strong. Finally, it has been recognized that the pre-oxidized polyacrylonitrile fibers of the third layer considerably increase the fire-resistance and are also very inexpensive. Pre-oxidized polyacrylonitrile fibers are oxidized polyacrylonitrile fibers.

Consequently, the following features of the present invention provide an inexpensive material that has high mechanical strength and is highly fire-resistant.

The first layer could be configured as a grid that is woven from para-aramid fibers. A grid made of para-aramid fibers is abrasion-resistant, tear-resistant and fire-resistant. The grid forms a cover layer and improves the abrasion resistance.

The first layer could be configured as a grid that is woven from meta-aramid fibers. A grid made of meta-aramid fibers is abrasion-resistant, tear-resistant and fire-resistant. The grid forms a cover layer and improves the abrasion resistance.

The first layer could have a weight per unit area of 35 g/m² to 50 g/m². A weight per unit area in this range imparts the material with the strength needed for use in vehicle seats. The grid forms a cover layer and improves the abrasion resistance.

The second layer could contain para-aramid fibers. A nonwoven made of para-aramid fibers is abrasion-resistant and fire-resistant. Such a nonwoven is more abrasion-resistant than the nonwoven of the third layer.

The second layer could contain meta-aramid fibers. A nonwoven made of meta-aramid fibers is abrasion-resistant and fire-resistant. Such a nonwoven is more abrasion-resistant than the nonwoven of the third layer.

The second layer could contain phenolic-resin fibers. A nonwoven made of phenolic-resin fibers is abrasion-resistant and fire-resistant. Such a nonwoven is more abrasion-resistant than the nonwoven of the third layer.

Before this backdrop, it is conceivable to produce a nonwoven consisting of a mixture of meta-aramid fibers, para-aramid fibers and/or phenolic-resin fibers. Such a nonwoven is more abrasion-resistant than the nonwoven of the third layer.

The second layer could have a weight per unit area of 35 g/m² to 55 g/m². A weight per unit area in this range imparts the material with the strength needed for use in vehicle seats. In particular, a good level of abrasion resistance is ensured.

The third layer could have a weight per unit area of 115 g/m² to 135 g/m². A weight per unit area in this range imparts the material with the strength needed for use in vehicle seats. The use of pre-oxidized polyacrylonitrile fibers is extremely advantageous since these are oxidized, thermally stabilized polyacrylonitrile fibers that do not burn, melt, soften or drip.

A vehicle seat, or especially an airplane seat, could contain a material including any of the above featurs. Thanks to its fire properties and strength, the material described here is especially well-suited for the manufacture of airplane seats.

The materials can be made by means of water-jet needling or mechanical needling of the second and third layers, a process in which these previously joined layers are then joined to the first layer. Here, a higher needle density is chosen on the side of the second layer and a lower needle density on the side of the third layer since the pre-oxidized polyacrylonitrile fibers can easily be damaged. The first layer is attached in such a way that it just barely does not become detached from the second and third layers. The second layer is positioned sandwich-like between the first and third layers.

It is likewise conceivable for the second layer to first be needled by means of water-jet needling or mechanical needling. Either in a second step or else at the same time, the first layer is attached to one side of the second layer. In another step, the third layer is attached to the second layer. The second layer is then held sandwich-like between the first and third layers. The three layers that form the entire composite can be joined together by means of water-jet needling or mechanical needling.

There are various possibilities to advantageously configure and refine the teaching of the present invention. In this context, reference is hereby made, on the one hand, to the claims below and, on the other hand, to the explanation below of preferred embodiments of the material according to the invention on the basis of the examples.

Preferred configurations and refinements of the teaching will also be explained in general terms in conjunction with the explanation of the preferred embodiments.

### EMBODIMENT 1

A material used for a fire-resistant finish for vehicle seats consists of at least three layers, the first layer being configured as a grid that is woven from para-aramid fibers. The grid has a weight per unit area of 45 g/m².

The second layer is configured as a nonwoven containing para-aramid fibers and having a weight per unit area of 50 g/m².

The third layer is configured as a nonwoven containing pre-oxidized polyacrylonitrile fibers (brand name Panox) and having a weight per unit area of 130 g/m².

### EMBODIMENT 2

A material used for a fire-resistant finish for vehicle seats consists of at least three layers, the first layer being configured as a grid that is woven from para-aramid fibers. The grid has a weight per unit area of 45 g/m².

The second layer is configured as a nonwoven containing meta-aramid fibers and having a weight per unit area of 50 g/m².

The third layer is configured as a nonwoven containing pre-oxidized polyacrylonitrile fibers (brand name Panox) and having a weight per unit area of 130 g/m².

### EMBODIMENT 3

A material used for a fire-resistant finish for vehicle seats consists of at least three layers, the first layer being configured as a grid that is woven from para-aramid fibers. The grid has a weight per unit area of 45 g/m².

The second layer is configured as a nonwoven containing phenolic-resin fibers (brand name Kynol) and having a weight per unit area of 50 g/m².

The third layer is configured as a nonwoven containing pre-oxidized polyacrylonitrile fibers (brand name Panox) and having a weight per unit area of 130 g/m².

### EMBODIMENT 4

A material used for a fire-resistant finish for vehicle seats consists of at least three layers, the first layer being configured as a grid that is woven from para-aramid fibers. The grid has a weight per unit area of 45 g/m².

The second layer is configured as a nonwoven containing a mixture of para-aramid fibers, meta-aramid fibers, and phenolic-resin fibers, each in equal parts by weight and having a weight per unit area of 50 g/m².

The third layer is configured as a nonwoven containing pre-oxidized polyacrylonitrile fibers (brand name Panox) and having a weight per unit area of 130 g/m².

### EMBODIMENT 5

A material used for a fire-resistant finish for vehicle seats consists of at least three layers, the first layer being configured as a grid that is woven from para-aramid fibers. The grid has a weight per unit area of 45 g/m².

The second layer is configured as a nonwoven containing a mixture of para-aramid fibers and meta-aramid fibers, each in equal parts by weight and having a weight per unit area of 50 g/m². The para-aramid fibers and meta-aramid fibers are configured as staple fibers.

The third layer is configured as a nonwoven containing pre-oxidized polyacrylonitrile fibers (brand name Panox) and having a weight per unit area of 130 g/m². The pre-oxidized polyacrylonitrile fibers are configured as staple fibers.

In one case, the first layer of embodiments 1 to 5 is configured as a cover layer that faces a woven cover fabric layer. The third layer especially faces foam materials. The second layer is held sandwich-like between the first and third layers.

### COMPARATIVE EXAMPLE 1

A material used for a fire-resistant finish for vehicle seats consists of at least three layers, the first layer being configured as a grid that is woven from para-aramid fibers. The grid has a weight per unit area of 45 g/m².

The second layer is configured as a nonwoven containing para-aramid fibers and having a weight per unit area of 50 g/m².

The third layer is configured as a nonwoven containing 70% by weight of pre-oxidized polyacrylonitrile fibers, 30% by weight of phenolic-resin fibers (brand name Kynol) and having a weight per unit area of 130 g/m².

### COMPARATIVE EXAMPLE 2

A material used for a fire-resistant finish for vehicle seats consists of at least three layers, the first layer being configured as a grid that is woven from para-aramid fibers. The grid has a weight per unit area of 45 g/m².

The second layer is configured as a nonwoven containing para-aramid fibers and having a weight per unit area of 50 g/m².

The third layer is configured as a nonwoven containing 50% by weight of melamine-resin fibers (brand name Basofil), 25% by weight of para-aramid fibers, 25% by weight of meta-aramid fibers, and having a weight per unit area of 130 g/m².

Embodiments 1 to 5 were each compared to Comparative Examples 1 and 2 and exposed to fire by means of a Bunsen burner. Especially the melamine-resin fibers of Comparative Example 2 became oxidized and lost mass in the flame. Moreover, it was observed that the meta-aramid fibers exhibited a relative high shrinkage in the flame, as a result of which tension was generated in the nonwoven. This can give rise to undesired cracks.

Embodiments 1 to 5 display far better fire resistance than the comparative examples. In particular, the pre-oxidized polyacrylonitrile fibers do not crumble or disintegrate in the fire and exhibit almost no loss of mass. Consequently, it is advantageous to use the cost-effective pre-oxidized polyacrylonitrile fibers, in spite of their relatively low mechanical strength.

Regarding other advantageous embodiments and refinements of the teaching according to the invention, reference is hereby made, on the one hand, to the general part of the description and, on the other hand, to the accompanying patent claims.

In conclusion, special mention is hereby made of the fact that the embodiments chosen above serve merely to elucidate the teaching according to the invention and that the invention is not limited to these embodiments.

What is claimed is:

1. A material providing a fire-resistant finish for vehicle seats, the material comprising:
a first layer in the form of a grid;
a second nonwoven layer including aramid fibers; and
a third nonwoven layer including pre-oxidized polyacrylonitrile fibers.

2. The material as recited in claim 1, wherein the grid of the first layer is woven with para-aramid fibers.

3. The material as recited in claim 1, wherein the grid of the first layer is woven with meta-aramid fibers.

4. The material as recited in claim 1, wherein the first layer has a weight per unit area in a range of 35 g/m² to 50 g/m².

5. The material as recited in claim 1, wherein the second layer includes para-aramid fibers.

6. The material as recited in claim 1, wherein the second layer includes meta-aramid fibers.

7. The material as recited in claim 1, wherein the second layer includes phenolic-resin fibers.

8. The material as recited in claim 1, wherein the second layer has a weight per unit area in a range of 35 g/m² to 55 g/m².

9. The material as recited in claim 1, wherein the third layer has a weight per unit area in a range of 115 g/m² to 135 g/m².

10. A vehicle seat including a material having a fire-resistant finish, the material comprising:
a first layer in the form of a grid;
a second nonwoven layer including aramid fibers; and
a third nonwoven layer including pre-oxidized polyacrylonitrile fibers.
